(19) United States
(12) Patent Application Publication
(10) Pub. No.: US 2026/0361065 A1
(43) Pub. Date: Nov. 12, 2026

(54) REMOVABLE LOGO INSERT

(71) Applicant: Hubbell Incorporated, Shelton, CT (US)

(72) Inventors: Robert Wilton Fox, Greenback, TN (US); Bunnie Ann Wilhelmi, Knoxville, TN (US)

(21) Appl. No.: 19/667,028

(22) Filed: May 4, 2026

Related U.S. Application Data
(60) Provisional application No. 63/802,942, filed on May 9, 2025.

(51) Int. Cl. H02G 9/00; G09F 7/18

(52) U.S. Cl. CPC H02G 9/00; G09F 7/18

(57) ABSTRACT

A cover system for an outdoor electrical enclosure includes a cover, an indicator plate, and a fastener. The cover has an upper surface and a lower surface opposite to the upper surface. The upper surface includes a recess and a fastening aperture that extends through the cover to the lower surface. The indicator plate is removably coupled within the recess of the cover. The indicator plate includes a marking. The fastener is inserted through the fastening aperture to couple the cover to the indicator plate.

### FIELD

This claims the benefit of U.S. Provisional Application No. 63/802,942, filed May 9, 2025, the contents of which is incorporated herein by reference in its entirety.

The present disclosure relates to an electrical or utility enclosure. More particularly, the present disclosure relates to a logo insert of the electrical or utility enclosure.

### BACKGROUND

Covers for enclosures (e.g., underground enclosures) may include indicia that can communicate information about the enclosure and/or components housed within the enclosure. For example, the indicia may include alphanumeric text that can be used to identify the specific enclosure. To mass produce enclosure covers, distributors may want generic (i.e., un-customized) covers that can be customized by the end customer.

An end user (e.g., a utility company, a municipality, etc.) may add a marking or other indicator to identify the specific cover. However, current indicators may fall off, become dislodged, or otherwise removed. A need exists to better secure indicators to the cover.

### SUMMARY

Various examples of the present disclosure can overcome various of the aforementioned and other disadvantages associated with known terminal connectors and offer new advantages as well.

In some forms, there is a cover system for an outdoor electrical enclosure that includes a cover, an indicator plate, and a fastener. The cover has an upper surface and a lower surface opposite to the upper surface. The upper surface includes a recess and a fastening aperture that extends through the cover to the lower surface. The indicator plate is removably coupled within the recess of the cover. The indicator plate includes a marking. The fastener is inserted through the fastening aperture to couple the cover to the indicator plate.

In some forms, an outdoor enclosure includes an enclosure body, a cover, an indicator plate, and a fastener. The enclosure body has a wall that at least partially defines an internal volume. The cover is selectively coupled to the enclosure body and can at least partially enclosure the internal volume. The cover includes an upper surface and a lower surface opposite to the upper surface. The upper surface includes a recess and a fastening aperture that extends through the cover to the lower surface. The indicator plate is removably coupled within the recess of the cover. The indicator plate includes a marking. The fastener is inserted through the fastening aperture to couple the cover to the indicator plate.

In some forms, a method of installing an outdoor enclosure includes positioning an enclosure body in the ground. The enclosure body includes a wall that at least partially forms an internal volume. The method also includes connecting a cover to the enclosure body to at least partially enclose the internal volume. The cover includes a lower surface facing the internal volume, an upper surface opposite to the lower surface, and a recess formed in the upper surface. The method further includes creating a custom indicator having a marking and positioning the indicator within the recess. Finally, the method includes inserting a fastener through the lower surface of the cover to connect the cover to the indicator.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompanying drawing wherein:

FIG. 1 is an exploded view of a cover system for an outdoor enclosure.

FIG. 2 is a perspective view of an indicator of the cover system of FIG. 1.

FIG. 3 is a cross-sectional view of the indicator of FIG. 2 viewed along section 3-3.

FIG. 4 is a cross-sectional view of the cover system with the indicator coupled to a cover.

FIG. 5 is a perspective view of an enclosure that includes the cover system of FIG. 1 coupled to an enclosure base.

FIG. 6 is a cross-sectional view of the enclosure of FIG. 5, viewed along section 6--6.

### DETAILED DESCRIPTION

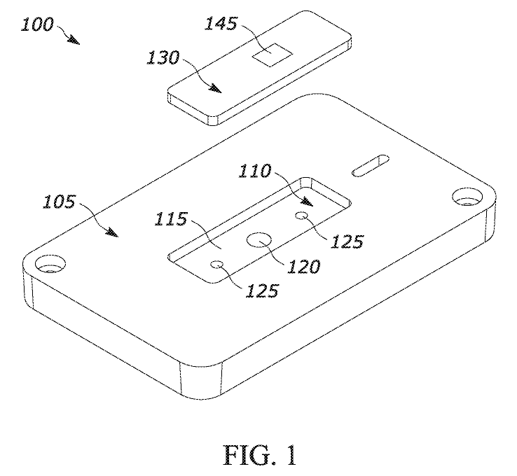

FIG. 1 illustrates a cover 100 for an underground enclosure 25. The cover 100 may fit within an opening of an enclosure base to at least partially enclose an internal volume of the enclosure base 50. The cover 100 may be removable coupled to the enclosure base 50 (e.g., with fasteners 55) to limit removal of the cover 100 from the enclosure base 50.

In some forms, the enclosure cover 100 may be constructed from a substantially rigid material. For example, the cover 100 may be constructed from polymer concrete, although other examples of the cover 100 may be constructed from different materials (e.g., sheet molding compound (SMC), high-density polyethylene (HDPE), etc.).

With continued reference to FIG. 1, an upper surface 105 (e.g., a surface facing away from the interior volume of the enclosure base 50 in the coupled position) of the cover 100 may include a recess 110. In the illustrated example, the recess 110 may be disposed proximate to a center of the upper surface 105. However, the recess 110 may be disposed at other locations in other examples of the cover 100.

In some forms, the recess 110 may have a substantially rectangular shape. However, other examples of the recess 110 may have a different shape (e.g., circular, elliptical, triangular, etc.).

In some forms, the recess 110 may descend partially through the cover 100 a first distance from the upper surface 105. In certain forms, the first distance may be between about 0.01 inches and about 5 inches. In certain forms, the first distance may be between about 0.05 inches and about 2.5 inches. In certain forms, the first distance may be between about 0.1 inches and about 1 inch. In certain forms, the first distance may be between about 0.25 inches and about 0.75 inches. In certain forms, the first distance may be about 0.5 inches.

With continued reference to FIG. 1, a depressed surface 115 of the recess 110 may include one or more openings (e.g., three shown). The illustrated openings may extend entirely through the cover 100 between the depressed surface 115 and a lower surface.

In some forms, the depressed surface 115 may include a central opening 120 disposed proximate to a center of the depressed surface 115. A fastener opening 125 may be disposed on either side of the central opening 120 proximate to an outer edge of the depressed surface 115.

In certain forms, centers of the central opening 120 and the fastener openings 125 may be aligned along an axis that extends along a length of the depressed surface 115. The central opening 120 may have a larger width than the fastener openings 125. Although in other examples, the width of one or more of the fastener openings 125 may be equal to or greater than the width of the central opening 120.

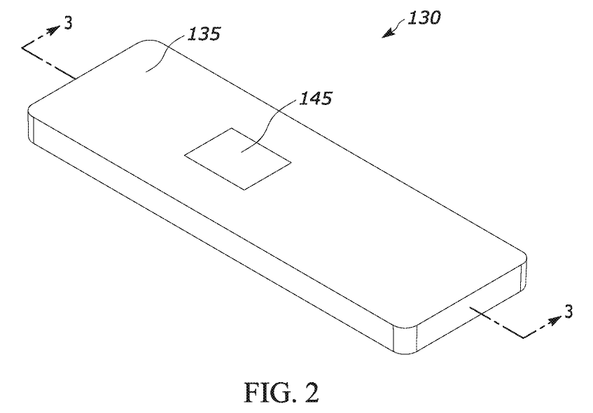

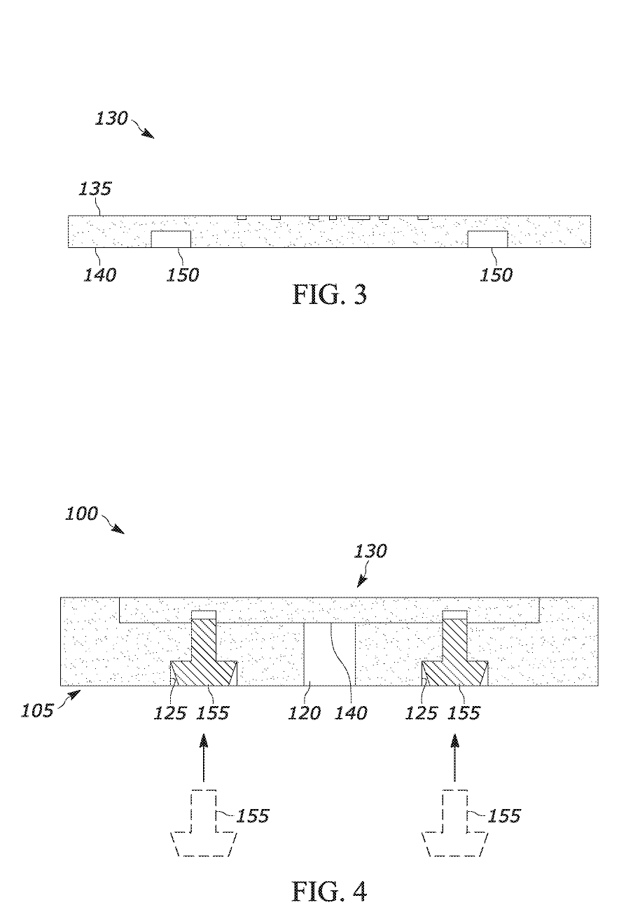

As shown in FIGS. 2 and 3, an indicator 130 may have an outer perimeter that substantially matches the shape of the recess 110. For examples, the indicator 130 may have a substantially rectangular shape, although other examples of the indicator 130 may have a different shape.

The illustrated indicator 130 may be formed from a substantially rigid material. For example, the indicator 130 may be constructed from the same material as the cover 100 (e.g., polymer concrete, SMC, HDPE, etc.). However, other examples of the indicator 130 may be constructed from a different material.

As shown in FIG. 3, the indicator 130 may include an upper surface 135 and a lower surface 140 opposite to the upper surface 135. In the illustrated example, the upper surface 135 may include an indicium 145 (see e.g., FIG. 3). In some forms, the indicia 145 may be alphanumeric text, symbols, and/or colors that communicate features about the enclosure 25 and/or a component housed in the interior volume of the enclosure 25.

With continued reference to FIG. 3, a pair of fastening apertures 150 may be formed in the lower surface 140 of the indicator 130. In the illustrated example, the fastening apertures 150 may each be disposed proximate to an outer edge of the indicator 130. In the illustrated example, the centers of the apertures 150 may be aligned along a central axis of the indicator 130. However, other examples may include the apertures 150 in different positions.

Returning to FIG. 1, the indicator 130 may be coupled to the cover 100. For examples, the indicator 130 may be positioned within the recess 110. In some forms, the thickness of the indicator 130 may be approximately the thickness of the recess 110. Thus, the indicator 130 may be substantially flush against the upper surface 105 when it is inserted within the recess 110.

As shown in FIG. 4, the apertures 150 of the indicator 130 may be aligned with the fastener openings 125 of the cover 100 when the indicator 130 is received within the recess 110. Fasteners 155 may be inserted through each of the aligned pairs of fastener openings 125 and apertures 150 to secure the indicator 130 to the cover 100.

In use, the cover 100 may be manufactured separately from the indicator 130. This may permit a customer to stock generic covers 100 that can be used in a variety of locations (e.g., and are not pre-labeled for a specific use). Indicators 135 may be manufactured for specific uses (e.g., to communicate specific information) and positioned within the recess 110 to customize the cover 100.

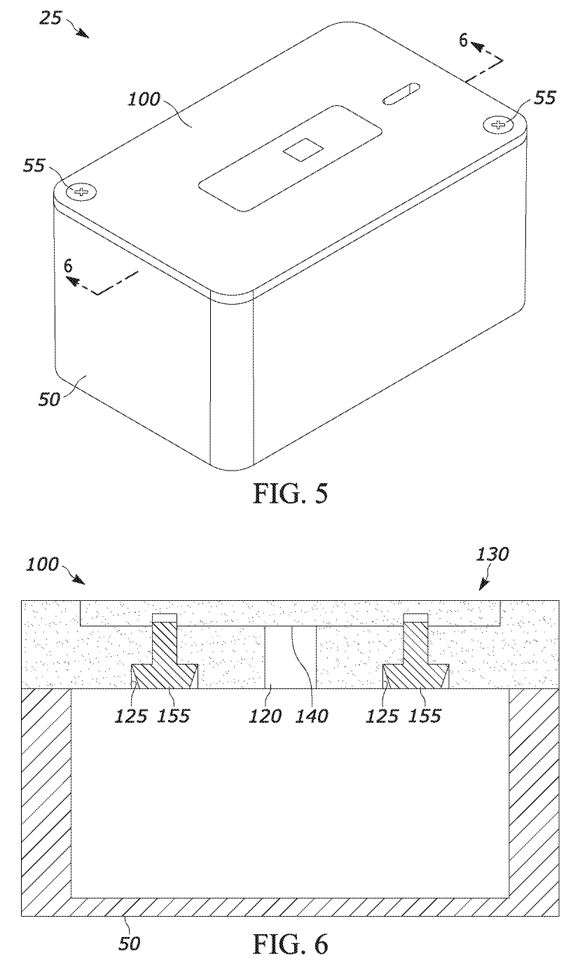

In some forms, the fasteners 155 may act as tamper-resistant fasteners. As shown in FIGS. 5 and 6, the head of each fastener 155 may be disposed proximate to a lower surface of the cover 100, which may face an interior of the enclosure base 50. This may limit inadvertent and/or unauthorized removal of the indicator 130 from the cover 100 because the heads of the fasteners 155 may be inaccessible when the cover 100 is engaged with an enclosure base 50. Specifically, the cover 100 may completely enclose interior volume of the enclosure base 50 so that the fasteners 155 are inaccessible when the cover 100 remains secured to the enclosure base 50.

In some forms, the central opening 120 may act as a drainage opening, which may assist in limiting liquid accumulation within the recess 110. For example, precipitation and/or condensation may cause liquid to enter the recess 110. In environments where the temperature cycles above and below the freezing point, liquid that was permitted to accumulate within the recess could freeze and then thaw, which could expand and contract against the indicator 130 and eventually damage the indicator and/or decouple the indicator from the cover 100. The central opening 120 permits the drainage of liquid out of the recess 110 to limit the accumulation of liquid that could cycle between freezing and thawing. The width of the central opening 120 may be sufficiently large (e.g., at least about 0.5 inches) to limit blockages (e.g., from debris) that could obstruct drainage.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1. A cover system for an outdoor electrical enclosure, the cover system comprising:
a cover having an upper surface and a lower surface opposite to the upper surface, wherein the upper surface includes a recess and a fastening aperture that extends through the cover to the lower surface;
an indicator plate removably coupled within the recess of the cover, wherein the indicator plate includes a marking; and
a fastener inserted through the fastening aperture to couple the cover to the indicator plate.

2. The cover system of claim 1, wherein the cover and the indicator plate are both constructed from polymer concrete.

3. The cover system of claim 1, wherein at least one of the cover and the indicator plate are constructed from sheet molding compound (SMC) or high-density polyethylene (HDPE).

4. The cover system of any one of claims 1 - 3, wherein the marking includes an alphanumeric symbol, a color, and/or a picture that is configured to communicate information to a user.

5. The cover system of any one of claims 1 - 4, further comprising a drain aperture that extends through the recess, wherein the drain aperture is configured to permit liquid to pass through the cover.

6. The cover system of claim 5, wherein the fastening aperture is a first fastening aperture, the cover system further comprising a second fastening aperture that extends through the cover to the lower surface, and wherein the drain aperture is disposed between the first fastening aperture and the second fastening aperture.

7. The cover system of claim 5 or claim 6, wherein the drain aperture has a width of at least 0.5 inches.

8. The cover system of any one of claims 1 - 7, wherein a lower surface of the recess is depressed at least 0.5 inches from the upper surface.

9. The cover system of any one of claims 1 - 8, wherein the recess has a rectangular shape.

10. The cover system of any one of claims 1 - 9, wherein the fastener includes a fastener head that has a width greater than a width of the fastening aperture, and wherein the fastener head is configured to contact the lower surface when inserted through the fastening aperture.

11. An outdoor electrical enclosure comprising:
an enclosure body having a wall that at least partially defines an internal volume;
a cover selectively coupled to the enclosure body and configured to at least partially enclosure the internal volume, wherein the cover includes an upper surface and a lower surface opposite to the upper surface, wherein the upper surface includes a recess and a fastening aperture that extends through the cover to the lower surface;
an indicator plate removably coupled within the recess of the cover, wherein the indicator plate includes a marking; and
a fastener inserted through the fastening aperture to couple the cover to the indicator plate.

12. The outdoor enclosure of claim 11, wherein the cover and the indicator plate are both constructed from polymer concrete.

13. The cover system of claim 11, wherein at least one of the cover and the indicator plate are constructed from sheet molding compound (SMC) or high-density polyethylene (HDPE).

14. The outdoor enclosure of any one of claims 11 - 13, wherein the marking includes an alphanumeric symbol, a color, and/or a picture that is configured to communicate information to a user.

15. The outdoor enclosure of any one of claims 11 - 14, further comprising a drain aperture that extends through the recess, wherein the drain aperture is configured to permit liquid to pass through the cover.

16. The outdoor enclosure of claim 15, wherein the fastening aperture is a first fastening aperture, the outdoor enclosure further comprising a second fastening aperture, and wherein the drain aperture is disposed between the first fastening aperture and the second fastening aperture.

17. The outdoor enclosure of claim 15 or claim 16, wherein the drain aperture has a width of at least 0.5 inches and is configured to allow liquid to pass from the recess and into the internal volume.

18. The outdoor enclosure of any one of claims 11 - 17, wherein a lower surface of the recess is depressed at least 0.5 inches from the upper surface.

19. The outdoor enclosure of any one of claims 11 - 18, wherein the recess has a rectangular shape.

20. The outdoor electrical enclosure of any one of claims 11 - 19, wherein the fastener includes a fastener head that has a width greater than a width of the fastening aperture, and wherein the fastener head is configured to be received within the internal volume when inserted through the fastening aperture.

21. A method of installing an outdoor enclosure, the method comprising:
positioning an enclosure body in the ground, wherein the enclosure body includes a wall that at least partially forms an internal volume;
connecting a cover to the enclosure body to at least partially enclose the internal volume, wherein the cover includes a lower surface facing the internal volume, an upper surface opposite to the lower surface, and a recess formed in the upper surface;
creating a custom indicator having a marking;
positioning the indicator within the recess; and
inserting a fastener through the lower surface of the cover to connect the cover to the indicator.

22. The method of claim 21, wherein the cover and the indicator are both constructed from polymer concrete.

23. The method of claim 21, wherein at least one of the cover and the indicator plate are constructed from sheet molding compound (SMC) or high-density polyethylene (HDPE).

24. The method of any one of claims 21 - 23, wherein the cover further concludes a drain aperture that extends through the recess, wherein the drain aperture is configured to permit liquid to pass through the cover.

25. The method of any one of claims 21 - 24, wherein the marking includes an alphanumeric symbol, a color, and/or a picture that is configured to communicate information to a user.

26. The method of any one of claims 21 - 25, wherein indicator includes a first aperture and the recess includes a second aperture, wherein the method further includes aligning the first aperture with the second aperture and inserting the fastener through the first aperture and the second aperture.

27. The method of claim 26, wherein the first aperture extends only partially through the indicator, and wherein the fastener is not visible from the upper surface when the indicator is positioned within the recess.

28. The method of any one of claims 21 - 27, wherein the recess has a rectangular shape.
